(19) United States
(12) Patent Application Publication
(10) Pub. No.: US 2004/0148612 A1
(43) Pub. Date: Jul. 29, 2004

(54) System and method for generating an application programming interface from a schema

(76) Inventor: Jesse Olsen, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/352,353

(22) Filed: Jan. 27, 2003

(51) Int. Cl. G06F 3/00

(52) U.S. Cl. 719/328

(57) ABSTRACT

A system and method are disclosed for generating an application programming interface (API) comprising parsing a schema defining a description language data structure, automatically creating an accessible data structure reflecting all relationships depicted in the parsed schema, and automatically generating code for at least one function based on the parsed schema, wherein the code is based on accessing the accessible data structure.

### BACKGROUND

Extensible Markup Language (XML) is quickly becoming the standard computer technology for many different information-intensive applications. Originally created as a flexible markup language for describing and structuring data, XML is now being used in everything from database management to distributed Internet applications. XML is a simplified version or sub-language of Standard Generalized Markup Language (SGML). SGML is a meta-language that includes an extremely comprehensive, yet rule-intensive, capability for electronically defining documents. Hypertext Markup Language (HTML) is also a sub-set language of SGML geared toward describing the format or appearance of documents. XML was intended to be a less restrictive document description language than SGML, yet still maintain connections to SGML. The flexibility and extensibility of XML allows a virtually limitless array of applications. For example, Web Services Description Language (WSDL) is an XML-based description language for describing the functionality of Web services. Schema files are XML files that describe desired formats for XML documents intended for a particular domain. A schema includes definitions of the datatypes and structures for the desired domain.

In order to actually make use of XML, or any of its specialized spin-off description languages, an application programming interface (API) and an intermediate accessible data structure containing the XML data are typically needed. An API forms the interface between the data and functionality available in an XML document or domain and a developer. APIs have been written for many different applications. One such API for WSDL files is the open source WSDL4J (WSDL for JAVA™). Programmers examined the WSDL schema to program WSDL4J and expose the different methods or functions available for manipulating WSDL files. Document Object Model (DOM) is an API that is typically used to manipulate regular XML files through a generically accessible data structure. It was also coded by programmers to expose the functionality and data of XML to developers. Another example API is Castor. Castor is an open source data binding framework for JAVA™. It is generally used to manipulate XML Schema Description (XSD) documents.

With the ever increasing numbers of XML applications and/or description languages, programmers will be responsible for creating all the APIs by hand that are used to manipulate those applications or access the data by hand without the aide of an API. Furthermore, industries that create customized XML applications and/or description languages will generally have to create custom APIs for using those applications. The potential costs in programmer time would likely be quite high. Also, the naming conventions for each API will typically vary depending on the language selections made by each individual programmer. For example, one API programmer may name a method or function for adding a type, “newType,” while another programmer may name a similar function, “addType.” Therefore, each embodiment of a different API for any particular XML application may have inconsistent names for similar-type functions creating a greater learning time for developers.

MICROSOFT VISUAL STUDIO.NET™ includes functionality to simplify and automate access and use of XML documents. By leveraging an intermediate data structure in its ADO.NET™ database adapter framework, VISUAL STUDIO.NET™ can use an XML schema to generate a DataSet. A DataSet is a data structure that typically arranges data or records retrieved from a database query into its own standardized database-like table structure (row/column format). ADO.NET™ is a database adapter intended to create an interface with any source of data. As part of the ADO.NET™ framework, a DataSet can be used to create a DataSet type that includes a standard set of properties, methods, and features for manipulating the DataSet. Therefore, VISUAL STUDIO.NET™ includes the functionality to convert an XML schema into an intermediate non-XML data structure that has an associated class or set of methods that can be generated based on the data structure. However, ADO.NET™ and VISUAL STUDIO.NET™ collapse the natural tree structure of XML into several singular tables. This retreat from the tree structure detrimentally causes loss of some of the information. While this feature reduces the dependence on human coders to physically code an API for any particular schema, using a non-XML data structure, such as the DataSet, that is formatted as a standard table, defeats some of the advantages of XML.

For example, in an address book application, if an XML schema defines an address book entry having a complex-type home address with a phone number and a complex-type work address with a phone number, where the phone number is also defined as a complex type having an area code element and a number element, VISUAL STUDIO.NET™ could not create a valid DataSet or corresponding API that reflects the complex phone number type under both the home address entry and the work address entry as that would create the same table nested in two different types/relations. VISUAL STUDIO.NET™ cannot generate more than one table having the same name. Thus, the functionality provided in VISUAL STUDIO.NET™ loses much of the beneficial informational relationships existing in the architecture of XML.

### SUMMARY

Embodiments are directed to a method for generating an application programming interface (API) comprising parsing a schema defining a description language data structure, automatically creating an accessible data structure reflecting all relationships depicted in the parsed schema, and automatically generating code for at least one function based on the parsed schema, wherein the code is based on accessing the accessible data structure.

Additional embodiments are directed to an automatic API generator comprising a parser for parsing a descriptor document describing an organization of a description language, an intermediate data generator for automatically creating a data structure preserving all relationships between the data as shown in the descriptor document and a code generator for automatically generating a logic function exposing the organization to a developer using the data structure.

Additional embodiments are directed to a computer program product having a computer readable medium with computer program logic recorded thereon, the computer program product comprising code for parsing an XML schema code for automatically creating a data structure representing all data relationships shown in the XML schema, and code for automatically generating code for one or more classes based on a structure discovered in the parsed XML schema.

Additional embodiments are directed to an API generator comprising a parser for automatically parsing a schema, the schema representing a domain format, a code generator for automatically generating an API using the parsed schema, and a data structure generator for automatically generating a data representation of the domain format of the schema.

### BRIEF DESCRIPTION OF THE DRAWINGS

FIG. 1 is a representation of a partial, example XML document;

FIG. 2A is a representation of an example XML schema configured to describe the format of the XML document, as represented in FIG. 1

FIG. 2B is a representation of another example XML schema;

FIG. 3 is a block diagram illustrating an exemplary embodiment of the teachings disclosed herein;

FIG. 4 is a block diagram detailing one manifestation of the API generator of the exemplary embodiment shown in FIG. 3;

FIG. 5A is a pseudo code example illustrating a partial data structure that is configured to hold data according to the nested relationships found in the XML schema of (FIG. 2B);

FIG. 5B is an example illustrating a partial data structure that is configured according to the table structure of the prior art when processing the XML schema of (FIG. 2B);

FIG. 6 illustrates a computer system adapted to use various embodiments of the present invention; and

FIG. 7 is a flowchart illustrating one exemplary embodiment of an API generator.

### DETAILED DESCRIPTION

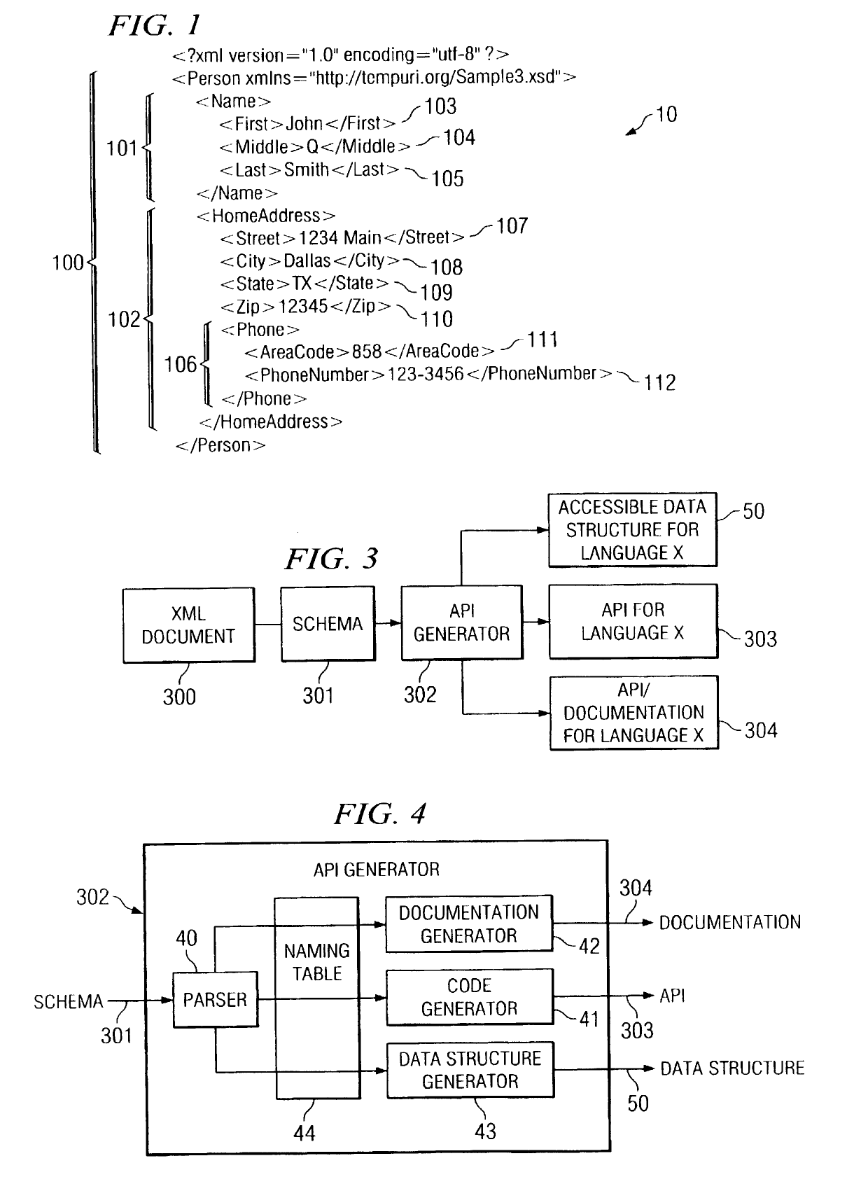

FIG. 1 is a representation of partial, example XML document 10. XML document 10 defines an address book entry for an individual as Person 100. Person 100 comprises Name 101 and HomeAddress 102. Name 101 entry includes child elements 103 -105. Child element 103 defines the first name of Name 101. Child element 104 defines the middle name, and child element 105 defines the last name. Thus, entry Name 101 includes branches representing the first, middle, and last name of the entry. HomeAddress 102 includes child elements 107-110. Child element 107 defines the street address, child element 108 defines the city, child element 109 defines the state, and child element 110 defines the zip code. HomeAddress 102 also includes Phone 106 child element that also comprises sub-child element 111 for the area code and sub-child element 112 for the phone number.

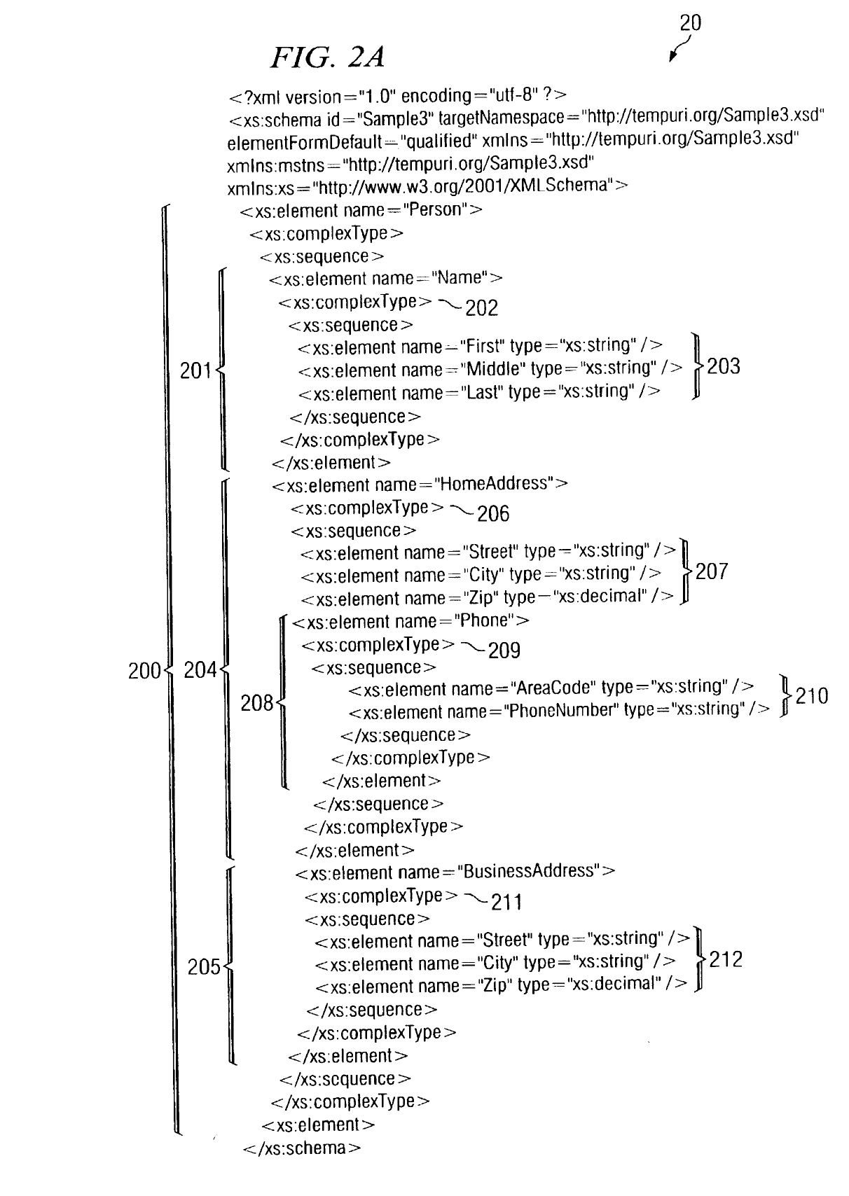

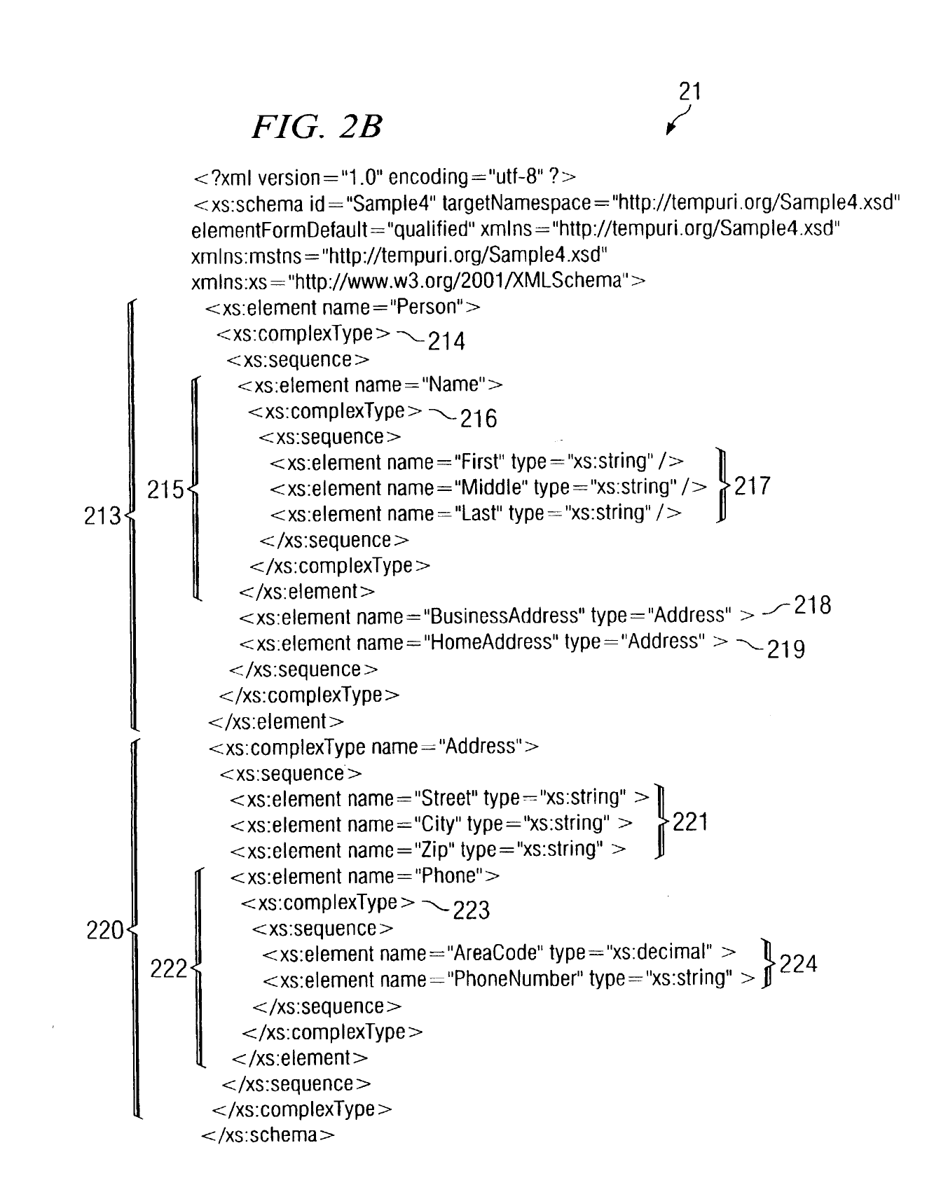

FIG. 2A is a representation of an example XML schema 20 configured to describe the format of XML document 10, as represented in FIG. 1. XML schema 20 includes several sections that define the proper format and structure of an XML document that needs to conform to the structure in FIG. 1. XML schema 20 includes definitions of the entire entry, Person 200, and the sub-elements, Name 201, HomeAddress 204, and BusinessAddress 205. Name 201 is defined as a complex type in line 202, meaning that it contains multiple elements 203. HomeAddress 204 is also defined as a complex type in line 206 including multiple address elements 207. HomeAddress 204 also includes definition of Phone 208 as a complex type in line 209 that includes child elements 210. BusinessAddress 205 is defined as a complex type in line 211 that includes child elements 212.

FIG. 2B is a representation of another example XML schema 21. XML document 10 (FIG. 1) may also be compatible with XML schema 21. However, XML schema 21 avoids duplication of data structures by defining a structure once, then referencing it multiple times. Schema 21 defines Person 213 as a complex type in line 214 to include Name 215, BusinessAddress 218, and HomeAddress 219. Name 215 is defined as a complex type in line 216 with child elements 217. BusinessAddress 218 and HomeAddress 219 are defined as type Address 220. Type Address 220 is defined having child elements 221 and another child element, Phone 222, which is defined as a complex type in line 223. Complex child element Phone 222 is defined to include sub-elements 224. While XML schema 21 is compatible with XML document 10 (FIG. 1), VISUAL STUDIO.NET™ would not be capable of handling this version due to the dual nesting of complex child element Phone 222. Because the tables that would be generated would have the same name, VISUAL STUDIO.NET™ could not include Phone 222 in both BusinessAddress 218 and HomeAddress 219, but instead would return an error message without generating the API. However, various embodiments of API generators as described herein, would be able to generate an API for either version of the schema.

FIG. 3 is a block diagram illustrating an exemplary embodiment of the teachings disclosed herein. XML document 300 contains data and conforms to the format and structure as described by schema 301. Because schema 301 includes a complete vocabulary or description of the structure and format of XML document 300, it also contains information on the possible different classes, functions, and methods that could be created to take advantage of the information within XML document 300. In accordance with teachings of an embodiment of the present invention, schema 301 is passed into API generator 302. API generator 302 parses through the structure of schema 301. Instead of creating a flat group of tables that is not completely compatible with XML, as in MICROSOFT'S VISUAL STUDIO.NET™, API generator 302 uses the parsed structure to automatically create accessible data structure 50 for any given language X, where X can be any type of programming language, such as SUN JAVA™, C/C++, Perl, PYTHON, MICROSOFT VISUAL BASIC™, MICROSOFT C#™, MICROSOFT J#™, Lisp, SmallTalk, COBOL, Fortran, Pascal, Modula, or the like, which places the XML data in a format that is compatible with any given accessing application, and automatically generate API 303 using any given coding language X, as described above. Application developers that desire to program applications using XML document 300 may then use API 303 to extract the XML data that is now exposed through accessible data structure 50. API Generator 302 may also generate a set of instructions of documentation for API 303 in API/Database Documentation 304 for the specific language X used.

Code generators are well-known in the art. The code generator in the described embodiment may be customized to produce consistent naming to define common type classes or methods, such as for adding or deleting new nodes, getting or setting specific values, and the like. Thus, each schema that is run through API generator 301 will produce an API that is specific to the particular XML application, but that also uses a common naming convention. This allows developers to more easily program with the APIs that are automatically generated by the described embodiment.

FIG. 4 is a block diagram detailing one manifestation of API generator 302 of the exemplary embodiment shown in FIG. 3. API generator 302, of the illustrated embodiment, includes parser 40, code generator 41, documentation generator 42, and data structure generator 43. As schema 301 is forwarded to API generator 302, parser 40 parses the structure representing XML document 300. Parser 40 feeds the nested relationship structure of schema 301 to data structure generator 43 for defining the nested relationships in accessible data structure 50. Upon reading an attribute, format, or structure in schema 301, parser 40 also sends the structure representation to code generator 41. Code generator 41 generates code in any particular language X, as discussed above, to expose the attribute, format, or structure through an API method that takes advantage of and is based on accessible data structure 50. Parser 40 also passes the parsed structure to documentation generator 42, which examines the structure of schema 301 and generates documentation that describes the function of each method. In embodiments where code generator 41 may produce JAVA™ code, documentation generator 42 may comprise a version or implementation of SUN JAVADOC™. JAVADOC™ is a utility typically provided with most JAVA™ development kits that can be given some JAVA™ source code, and produces Hypertext Markup Language (HTML) pages describing the functions of the various classes, methods, and variables used. Therefore, when API generator 302 completes API 303, developers not only have the XML data in accessible form and a coded API for implementing applications using XML document 300, but also have documentation that may be useful for the developers to learn what the coded classes or methods do and/or what parameters may be necessary.

In an example of operation of the embodiment described in FIG. 4, if XML schema 20 (FIG. 2A) is run through parser 40, it may read that element Person 200 (FIG. 2A) supports additional elements. A method for adding or subtracting elements may be generated by code generator 41. Similarly, when parser 40 reads that the individual Name elements 203 (FIG. 2A) only contain data, a method for getting or setting the data of those elements may be generated by code generator 41. Once the classes or methods have been generated by code generator 41, documentation generator 42 may generate documentation for developers for each of the classes or methods. In each of the generation processes for API 303, documentation 304, and data structure 50, a consistent list of names may be used, such as in naming table 44, in order to maintain a standardized naming convention for each of the generated items.

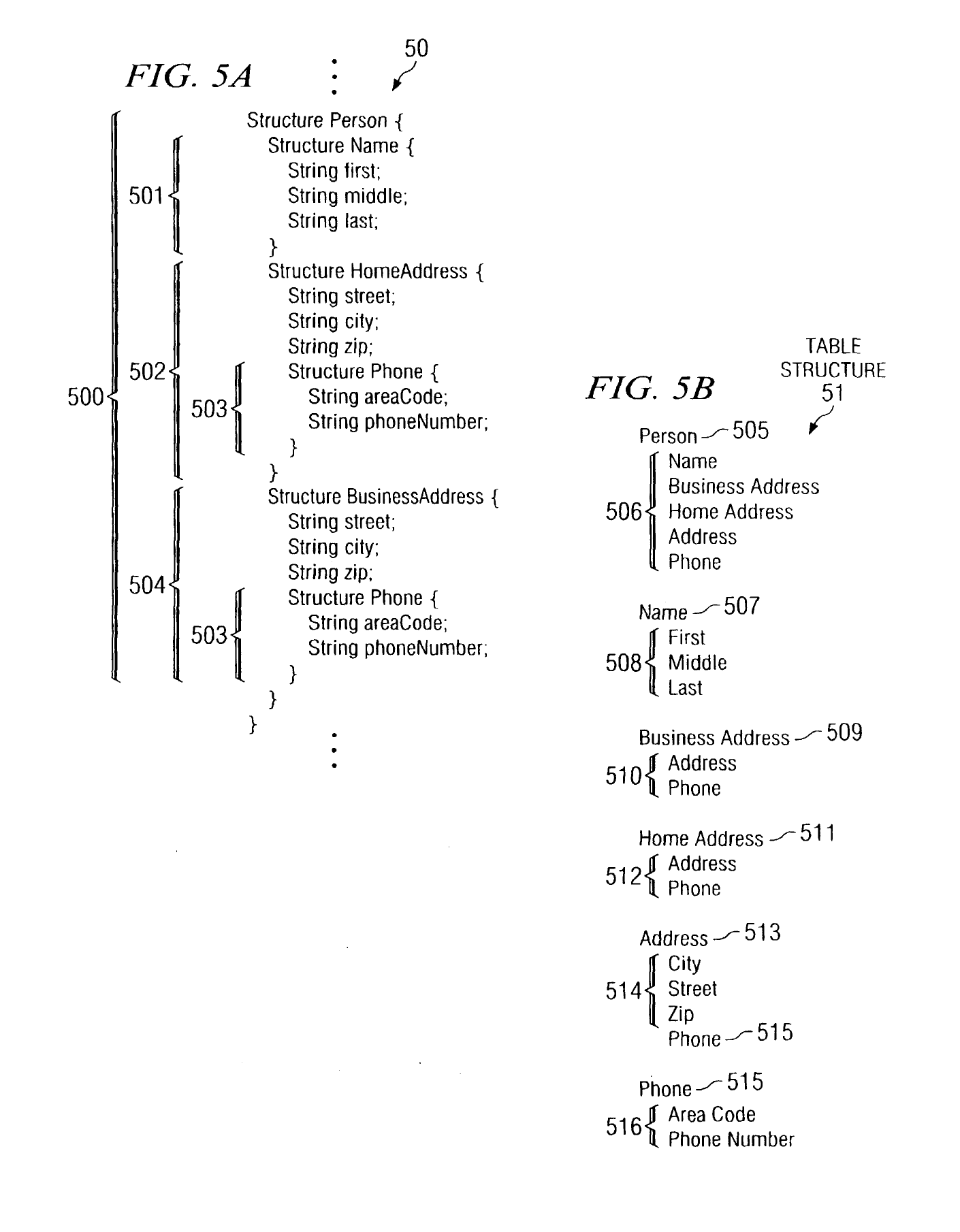

In operation, parser 40 (FIG. 4) parses XML schema 21 (FIG. 2B) and, in addition to providing the structure to code generator 41 (FIG. 4), provides the structure to data structure generator 43 (FIG. 4). Data structure generator 43 then generates a data structure that may not only hold the information, but also maintains the nested relationships of the XML data. FIG. 5A is a pseudo code example illustrating partial data structure 50 that is configured to hold data according to the nested relationships found in XML schema 21 (FIG. 2B). As is evident from data structure 50, the structure closely resembles the structure and relationship in XML schema 21 (FIG. 2B). Data structure 50 includes the main element, Person 500, that includes a first complex element, Name 501, a second complex element, HomeAddress 502, which also includes a nested complex element, Phone 503, and a third complex element, BusinessAddress 504, which includes another instance of the nested complex element, Phone 503. Therefore, the nested relationships within XML schema 21 (FIG. 2B) are fully preserved.

In contrast, VISUAL STUDIO.NET™ would attempt to create tables for each of the complex elements defined in XML schema 21. FIG. 5B is an example illustrating a partial data structure that is configured according to table structure 51 of the prior art when processing XML schema 21 of (FIG. 2B). Table structure 51 typically includes the root node table, Person table 505, that lists complex elements 506 from the schema. The structure continues by creating individual tables for each of complex elements 506. Name table 507 includes name elements 508. BusinessAddress table 509 includes elements 510 that are complex elements of the entire structure. It should be noted that, at this point, VISUAL STUDIO.NET™ would cease its operation and return an error message because the table structure cannot nest a complex element table within another complex element table. However, for purposes of examining the differences between the table structure and the data structure described herein, the process is continued. HomeAddress table 511 also includes complex elements 512, which also could not be processed by VISUAL STUDIO.NET™. Address table 513 includes address elements 514 and Phone table 515. It should be noted with regard to Address table 513, that not only would the table structures of VISUAL STUDIO.NET™ be incapable of handling the data because of the nested table, Phone table 515, it is further incapable of establishing address elements 514 because two different sets of data may exist; one for BusinessAddress 509 and one for HomeAddress 511. Finally, Phone table 515 includes phone elements 516 that define the entire 10-digit telephone number. Therefore, because the existing table-format data structures used by VISUAL STUDIO.NET™ cannot preserve the full nested relationship of XML schema 21, much of the information inherent in the tree structure is lost.

When implemented in software, the elements of API generator 302 may essentially be the code segments to perform the necessary tasks. The program or code segments may be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, and the like. The code segments may be downloaded via computer networks such as the Internet, Intranet, and the like.

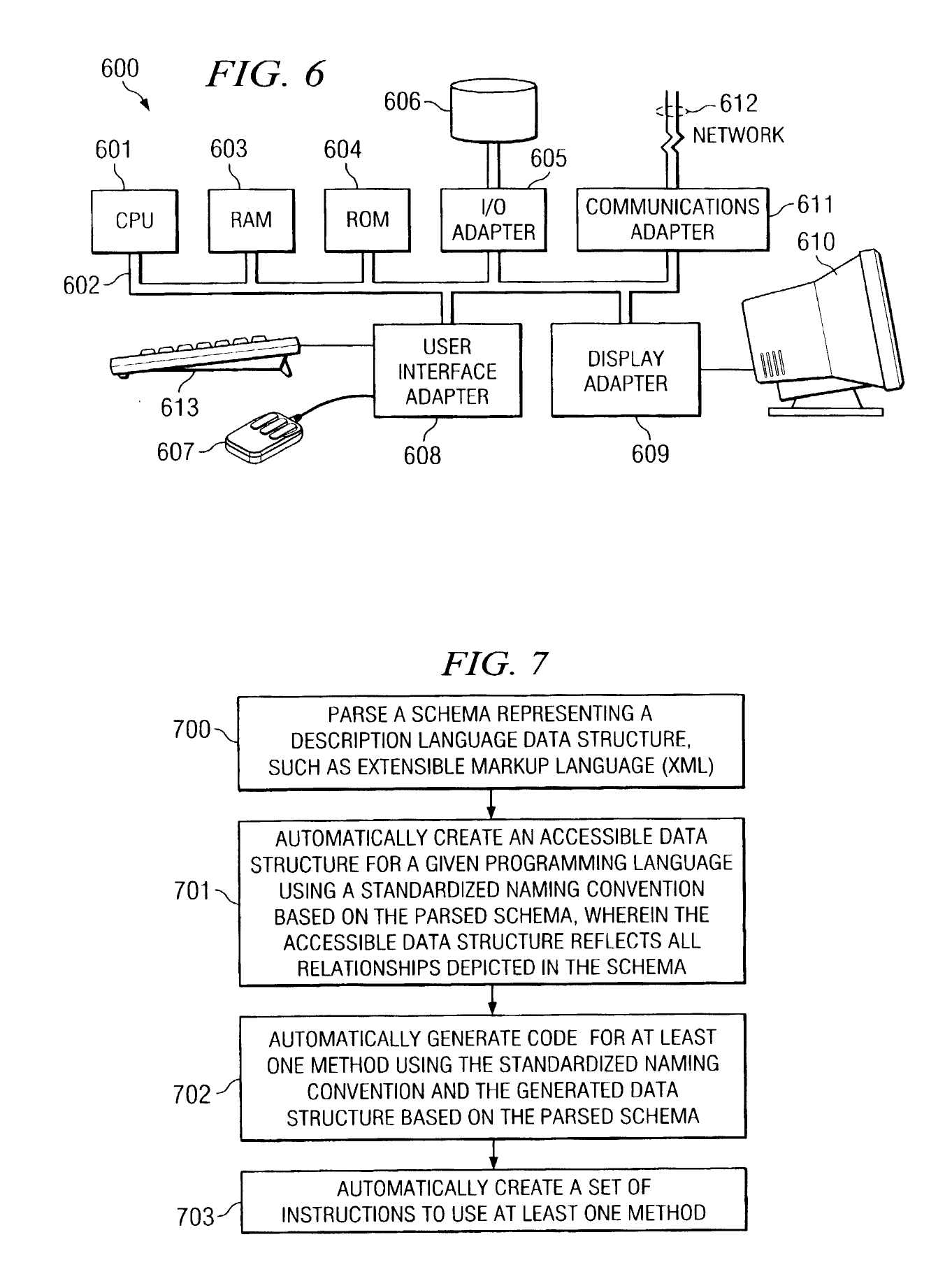

FIG. 6 illustrates computer system 600 adapted to use the present invention. Central processing unit (CPU) 601 is coupled to system bus 602. The CPU 601 may be any general purpose CPU, such as an INTERNATIONAL BUSINESS MACHINE (IBM) POWERPC™, INTEL™ PENTIUM™-type processor, or the like. However, the present invention is not restricted by the architecture of CPU 601 as long as CPU 601 supports the inventive operations as described herein. Bus 602 is coupled to random access memory (RAM) 603, which may be SRAM, DRAM, or SDRAM. ROM 604 is also coupled to bus 602, which may be PROM, EPROM, EEPROM, flash ROM, or the like. RAM 603 and ROM 604 hold user and system data and programs as is well known in the art.

Bus 602 is also coupled to input/output (I/O) controller card 605, communications adapter card 611, user interface card 608, and display card 609. The I/O adapter card 605 connects to storage devices 606, such as one or more of a hard drive, a CD drive, a floppy disk drive, a tape drive, to the computer system. The I/O adapter 605 would also allow the system to print paper copies of information, such as documents, photographs, articles, and the like. Such output may be produced by a printer (e.g. dot matrix, laser, and the like), a fax machine, a copy machine, or the like. Communications card 611 is adapted to couple the computer system 600 to a network 612, which may be one or more of a telephone network, a local (LAN) and/or a wide-area (WAN) network, an Ethernet network, and/or the Internet network. User interface card 608 couples user input devices, such as keyboard 613, and pointing device 607, to the computer system 600. The display card 609 is driven by CPU 601 to control the display on display device 610.

It should be noted that various embodiments of the API generator may be applicable to standardized versions of XML-type description languages, such as VoiceXML, Wireless Markup Language (WML), COMMERCE ONE's COMMON BUSINESS LIBRARY™ (CBL™), Mathematics Markup Language (MathML), and the like, and also customized or proprietary XML-type description languages. Various embodiments of the present invention may also be applicable to other data descriptive languages such as SGML and the like.

FIG. 7 is a flowchart illustrating one exemplary embodiment of the API generator. In step 700, a schema in a description language, such as XML, SGML, or the like, defining a description language data structure is parsed. In step 701, an accessible data structure is automatically created based on said parsed schema using a standardized naming convention, wherein the accessible data structure reflects all relationships depicted in the schema. In step 702, code for at least one method is automatically generated using the standardized naming convention and the generated data structure based on said parsed schema. In additional embodiments, a set of instructions may be also automatically created for said at least one method in step 703.

What is claimed is:

1. A method for generating an application programming interface (API) comprising:
parsing a schema defining a description language data structure;
automatically creating an accessible data structure reflecting all relationships depicted in said parsed schema; and
automatically generating code for at least one function based on said parsed schema, wherein said code is based on accessing said accessible data structure.

2. The method of claim 1 further comprising:
automatically creating a set of instructions to use said at least one function.

3. The method of claim 1 further comprising:
standardizing a naming convention for said at least one function.

4. The method of claim 1 wherein said description language data structure comprises one of:
Extensible Markup Language (XML); and
Standard Generalized Markup Language (SGML).

5. An automatic application programming interface (API) generator comprising:
a parser for parsing a descriptor document describing an organization of a description language;
an intermediate data generator for automatically creating a data structure preserving all relationships between said data as shown in said descriptor document; and
a code generator for automatically generating a logic function exposing said organization to a developer using said data structure.

6. The automatic API generator of claim 5 further comprising:
a documentation generator for automatically creating documentation about the use of said logic function.

7. The automatic API generator of claim 6 wherein said documentation includes:
definitions explaining a function of said logic function;
instructions disclosing parameters used in said logic function; and
identifications of objects returned by said logic function.

8. The automatic API generator of claim 5 further comprising:
a naming table accessible by said code generator for naming said automatically generated logic function.

9. The automatic API generator of claim 8 wherein said naming table is standardized to produce consistent names for logic functions having similar capabilities.

10. The automatic API generator of claim 5 wherein said code generator generates code in a computer programming language.

11. The automatic API generator of claim 10 wherein said computer programming language is selected from a group comprising:
JAVA™;
C/C++;
Perl;
C#™;
J#™;
SmallTalk™;
Pascal;
Modula;
PYTHON; and
VISUAL BASIC.

12. A computer program product having a computer readable medium with computer program logic recorded thereon, said computer program product comprising:
code for parsing an XML schema;
code for automatically creating a data structure representing all data relationships shown in said XML schema; and
code for automatically generating code for one or more classes based on a structure discovered in said parsed XML schema.

13. The computer program product of claim 12 further comprising:
code for automatically generating instructive documentation for said one or more classes.

14. The computer program product of claim 12 further comprising:
code for maintaining a standardized naming convention for use in conjunction with said code for automatically generating code.

15. The computer program product of claim 12 wherein said code for automatically generating said code generates code in a computer programming language.

16. The computer program product of claim 15 wherein said computer programming language is selected from a group comprising:
JAVA™;
C/C++;
Perl;
C#™;
J#™;
SmallTalk™;
Pascal;
Modula;
PYTHON; and
VISUAL BASIC.

17. An application programming interface (API) generator comprising:
a parser for automatically parsing a schema, said schema representing a domain format;
a code generator for automatically generating an API using said parsed schema; and
a data structure generator for automatically generating a data representation of said domain format of said schema.

18. The API generator of claim 17 further comprising:
an automatic documentation generator for generating a set of instructions for using said API.

19. The API generator of claim 17 further comprising:
a list of names for implementing a standardized naming convention for said API.

20. The API generator of claim 17 wherein said code generator generates code in a computer programming language.

21. The API generator of claim 20 wherein said computer programming language is selected from a group comprising:
JAVA™;
C/C++;
Perl;
C#™;
J#™;
SmallTalk™;
Pascal;
Modula;
PYTHON; and
VISUAL BASIC.
